(19) United States
(12) Patent Application Publication
(10) Pub. No.: US 2007/0016450 A1
(43) Pub. Date: Jan. 18, 2007

(54) Global health information system

(75) Inventors: Faiz Bhora, Narberth, PA (US); Christopher R. Kronenthal, Narberth, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: KroRa, LLC, Narberth, PA (US)

(21) Appl. No.: 11/181,423

(22) Filed: Jul. 14, 2005

(51) Int. Cl. G06F 19/00

(52) U.S. Cl. 705/3

(57) ABSTRACT

The Global Health Information System (GHIS) is an interoperable Electronic Medical Record (EMR) system that allows all players in the healthcare market instantaneous access to pertinent patient medical information from remote locations. Patient data formatted into a Global Chart (GC) is stored within a Centralized Data Repository (CDR) of a Global Health Information System. The Global Chart is constantly updated as well-defined triggers automatically append new pertinent data to it. The Global Chart is available at all times to the patient and accessible to the healthcare institutions and healthcare providers treating the patient. The Global Chart is able to interface with current electronic medical record systems, utilizing recently developed standards governing the secure, confidential transfer of electronic patient data. The Global Health Information System also provides a network of individual Internal Data Management Systems (IDMS) for healthcare institutions, allowing for standardization and uniformity at the institutional level. The Global Health Information System will thus serve as a single source for relevant patient information, as well as have the ability to transmit that information to all players in the healthcare market, especially to patients themselves.

### BACKGROUND OF THE INVENTION

1. Field of Invention

The present invention is related to heath information technology, and in particular, to the transfer of patient health information and data (e.g. electronic health records, electronic medical records) across institutions, with global patient, payer and provider access.

2. Description of Related Art

There is no doubt that computerized medical/health records make the delivery of healthcare safer, more efficient and in the long-term, more cost effective. All these attributes translate into better patient care. Yet according to recent reports, less than 9% of healthcare institutions in the United States have adopted an electronic health record or electronic medical record (EMR) system. The barriers to adoption are many: high initial cost, physician resistance to change, and lack of perceived benefits and limited usefulness due to interoperability between current systems. However, there is no doubt that improved electronic medical record systems are needed. President Bush highlighted this recently in his 2004 State of the Union Address, where he stated that electronic medical record systems could help avoid dangerous medical mistakes, reduce costs and improve care. On Apr. 24, 2004, he issued an Executive Order that called for the widespread deployment of health information technologies within ten years to help realize improvements in safety and efficacy.

There are currently over 250 electronic medical record systems in the market today, with about 20 larger vendors dominating the industry. In many ways, the electronic medical record software industry remains a cottage industry. The problem, however, is that each system functions in isolation. There is a medical record at every site the patient has ever visited, resulting in a very fragmented system with duplication of tests and procedures performed elsewhere but not accessible to the current institution.

The answer to this is interconnectivity or interoperability; the ability of different electronic medical record software systems to communicate with each other. It has been estimated that the health care industry could save as much as $300 billion a year if all patient records were in a digital format and able to be shared by all players-patients, providers and payers. This concept forms the basis of the government's creation of the National Health Information Infrastructure within the Department of Health and Human Services.

While the health services industry waits for a national health information network to take shape, they are turning to computerized Personal Health Records (PHRs) to fill this void. These PHRs are patient-owned and managed, unlike electronic medical records that are controlled by healthcare providers. Examples of such PHR services include WebMD's Health Manager, Laxor, FollowMe, CapMed's PHR product, and more recently, OnFile's PHR product and Medems iHealthRecords.

Achieving implementation of electronic medical record systems throughout the healthcare system is complex. Information is currently scattered across many computers (word processors, laboratory, billing, ECG carts) and within institutions (hospitals, physician offices, nursing facilities, pharmacies). To make this information useful and interoperable, four electronic medical record parameters must be met: Healthcare Message Exchange (HCME); Healthcare Terminology/Vocabulary (HCT/V); Security; and Object Model (OM) (e.g., structure and content).

Accepted standards currently exist for Message Exchange, Terminology and Security. However, there is no clear standard for an electronic medical record Object Model. There are three main organizations that create standards related to electronic medical records: Health Level Seven (HL 7), Committee European de Normalization or European Committee for Standardization (CEN TC 215) and the American Society for Testing and Methods (ASTM E31).

Health Level Seven has developed the most widely used healthcare-related electronic data exchange standards in North America, while CEN TC 215 is the preeminent healthcare technology standards developing organization in Europe. There is an effort to intensify collaboration between the two groups and a move towards the development of technically identical and interchangeable US and European standards. Both Health Level Seven and CEN collaborate with ASTM, which operates in the US and is mainly used by commercial laboratory vendors.

Health Level Seven, a non-profit organization, is one of several Standard Developing Organizations (SDOs) accredited by the American National Standard Institute. Health Level Seven focuses on interoperability and interface requirements between healthcare information systems based on consensus, openness and balance of interest. Health Level Seven Version 3, due for release soon, uses a well-defined methodology based on a reference information (i.e., data) model. It promises to be the most definitive standard to date. Using rigorous analytic and message building techniques and incorporating more trigger events and message formats with very little optionality, Health Level Seven's primary goal for Version 3 is to offer a standard that is definite and testable, and provide the ability to certify vendors conformance.

Version 3 uses an object oriented development methodology and a Reference Information Model (RIM) to create messages. The reference information model is an essential part of Health Level Seven Version 3 developmental methodology, as it provides explicit representation of the semantic and lexical connections that exist between the information carried in the fields of Health Level Seven messages. The reference information model is a large pictorial representation of the clinical data (domains) and identifies the life cycle of events that a message or groups of related messages will carry. It is a shared model between all the domains and as such is the model from which all domains create their messages. It is an all-encompassing, open-umbrella look at the entire scope of healthcare Information technology, containing more than 100 classes and more than 800 attributes used to create Health Level Seven messages.

Other evolving electronic medical record object model standards include the Clinical Document Architecture (CDA) standard and the Document Ontology Task Force (DOTF) proposal. The clinical document architecture standard provides an exchange model for clinical documents (such as discharge summaries and progress notes), and brings the healthcare industry closer to the realization of an electronic medical record system. Clinical document architecture documents can be structured in three levels: clinical document architecture level 1 represents a general clinical document; clinical document architecture levels 2 and 3 represent levels of specialization. The document ontology task force proposal suggests a classification of the clinical document architecture documents. It proposes a polyhierarchical taxonomy of document names, where each name is derived from a set of terminology axes.

There is currently no globally accessible, interoperable electronic medical record system. The current system of patient medical records involves storage of patient health data and information either as paper records in the vast majority of institutions or a combination of paper records and computerized electronic medical record software in the remainder. There is no cross-talk between current electronic medical record software, leading to fragmentation and duplication of healthcare information and delivery.

The healthcare industry is clearly moving towards a computerized, electronic patient health and medical record system. Electronic medical records have significant advantageous over paper records including improved patient safety, faster and more efficient patient care and the elimination of duplicating services that have been performed at other institutions. They reduce significant physician time expended in locating past medical data and in the long term are a significant source of cost savings to the healthcare industry. In addition, they allow improved means for education and research. Technology savvy patients are now demanding an electronic medical record system of their healthcare providers. Several payers are now providing financial incentives for institutions with an electronic medical record system. Both industry and the federal government have made this aspect of healthcare information technology a priority.

Current electronic medical record systems consist of customized software programs designed for the individual healthcare institution with no ability to communicate with each other or allow the electronic transfer of patient data, i.e., lack of interoperability. If a patient needs to see physicians at different institutions, he/she has to request paper copies/CD's of their records and have them physically delivered to the other institutions. These records are then attached to the patient's paper chart at the other institution, or if an electronic medical record system exists, filed somewhere. Further, patients are increasingly irate about having to fill the same information over and over again in similar forms each time they visit a healthcare provider. The current situation has lead most patients with chronic or severe diseases interacting with many physicians at different institutions to create their own personal medical record files and carry them on their person at all times. Clearly, this is not practical nor a long-term solution.

The problems with electronic medical record interconnectivity and interoperability are numerous. Firstly, until recently, no standards existed that dictated how patient information could be transmitted electronically in a safe, secure and patient authorized fashion. Several Standards Developing Organizations (SDOs) have very recently established such standards, with Health Level Seven being preeminent amongst them. Therefore, time is ripe for interoperability to occur.

A second reason for the current lack of interoperability is the inability of present electronic medical record systems to cross talk or transfer data from one system to another due to software constraints and limitations. In part, this was deliberately built into their design to discourage customers from switching to other electronic medical record systems, somewhat akin to the cell phone industry that in the past required change of phone numbers if one switched services. Future electronic medical record systems will have the ability to interconnect with each other, but in the meantime, there is a need to allow interoperability and continued use of these current systems by allowing transfer of data to a Centralized Data Repository (CDR) using specialized software programs and specialized interface engines.

A third reason for the lack of current interoperability is the reluctance of institutions to have completely open interconnectivity and loss of control over the information that is generated at their institutions. Healthcare institutions wish to pass on only pertinent patient data relevant to patient care and to restrict day-to day detailed or confidential information that, for example, would reveal the internal workings and proprietary practices of the institution. All references cited herein are incorporated herein by reference in their entireties.

### BRIEF SUMMARY OF THE INVENTION

To address the above discussed problems with interconnectivity and interoperability, the preferred embodiments of the present invention operate in accordance with standards (e.g., predominantly Health Level Seven), and are able to use all the latest standards within its system and have the ability to adapt to new and emerging standards. The preferred embodiments allow interoperability and continued use of these current systems by allowing transfer of data to a centralized data repository using specialized software programs, which circumvents the enormous problem of trying to make all 250+ current electronic medical record systems interoperable with each other. For example, the centralized data repository accepts, decodes and transfers patient information to other electronic medical record systems in a format suitable for their specifications, indirectly allowing interoperability.

The preferred embodiments accommodate for the desirability of institutions to control access to their information with the creation of a Global Chart (GC), which is stored in the centralized data repository. The Global Chart is designed to accept only core patient data that would be useful to a second institution in proving patient care. It thus filters out extraneous information (e.g., daily progress notes, nurse's notes, administrative notes, etc) that is valuable only to the initial institution and not critical or relevant to patient care. The present invention thus provides healthcare institutions with a layer of internal privacy using a Controlled-Interoperable System (CIOS) that is not possible with an Open Interoperable System (OIOS).

In accordance with a preferred embodiment, the Global Health Information System includes a centralized data repository, network-Internal Data Management System(s), and electronic medical record systems. Global Internal Data Management System users include physicians with access to the Global Health Information System or any other Global Health Information System-controlled Internal Data Management System(s) from a secure, remote location.

The preferred embodiments of the present invention thus solve the problem of interoperability with its unique architecture and design logic. Specifically, useful patient data is collected by the centralized data repository and stored in the Global Chart. This data is obtained from the electronic medical record system(s) currently in use at the healthcare providing institution using specialized software programs/interfaces, or from the Internal Data Management System (IDMSs) that the Global Health Information System will install at institutions that do not have an electronic medical record system. Although both the network-Internal Data Management System and electronic medical record systems are data management systems, the significant advantage of the network-Internal Data Management System over an electronic medical record system is that it is web-based, where as most current electronic medical records are locally installed software programs accessible only through a local server. Further, the unique architecture and design of the network-Internal Data Management System beneficially allows for a cleaner, more efficient and user-friendly interface with only a single log-on/sign-on. The unique design and architecture of the Global Chart and its ability to extract information from linked electronic medical record systems enables the transfer of data from one electronic medical record system to another without reconfiguring the design elements of the electronic medical record systems to suit every single other electronic medical record product. These unique elements make the preferred embodiments not only interoperable, but also portable or globally accessible. In summary, the preferred embodiments of the present invention thus provide an electronic medical record system that is interoperable, portable, standardized, secure, not necessarily patient-owned, yet always patient-controlled.

Further scope of applicability of the present invention will become apparent from the detailed description given hereinafter. However, it should be understood that the detailed description and specific examples, while indicating preferred embodiments of the invention, are given by way of illustration only, and that the invention is not limited to the precise arrangements and instrumentalities shown, since the invention will become apparent to those skilled in the art from this detailed description.

### BRIEF DESCRIPTION OF SEVERAL VIEWS OF THE DRAWINGS

The invention will be described in conjunction with the following drawings in which like reference numerals designate like elements and wherein:

FIG. 1 is a diagram showing the overall architecture of the Global Health Information System (GHIS) in accordance with a preferred embodiment of the invention;

FIG. 2 is a flowchart showing the basic architecture of the centralized data repository in accordance with a preferred embodiment;

FIG. 3 is a diagram illustrating the details of the centralized data repository architecture shown, for example, in FIG. 2;

FIG. 4 is a flowchart showing the bi-directional exchange of core patient data from both Internal Data Management System(s) and electronic medical record systems and the centralized data repository, in accordance with a preferred embodiment;

FIG. 5 is a diagram showing the details of the Internal Data Management System architecture in accordance with a preferred embodiment of the invention;

FIG. 6 is a flowchart showing the interaction between Internal Data Management System/electronic medical record systems and the centralized data repository in accordance with a preferred embodiment;

FIG. 7 is a flowchart showing both patient and healthcare provider interaction with the centralized data repository in accordance with a preferred embodiment;

FIG. 8 is a flowchart showing how patient data in an exemplary electronic medical record system is appended to the Global Chart;

FIG. 9 is a flowchart showing an interaction between a member and non-member healthcare entity with the centralized data repository in accordance with preferred embodiments of the invention;

FIG. 10 is a flowchart showing how member and non-member patients interact with the exemplary Global Health Information System in accordance with preferred embodiments of the invention;

FIG. 11 is a flowchart showing an example of how non-member physicians/institutions access the Global Chart in accordance with the preferred embodiments of the invention

FIG. 12 is a flowchart showing an example of member and non-member healthcare providers' interaction with the Global Health Information System (from an Internal Data Management System, an electronic medical record system, or a remote location) in accordance with preferred embodiments of the invention;

FIG. 13 is a flowchart showing how patient medical records are sent from healthcare institutions to the Global Health Information System in accordance with the preferred embodiments of the invention; and

FIG. 14 is a flowchart showing how data stored in the Global Health Information System is sent out to requesting healthcare institutions and requesting entities.

### DETAILED DESCRIPTION OF PREFERRED EMBODIMENTS OF THE INVENTION

The present invention is the first interoperable, portable, standardized, secure and patient-controlled electronic medical record system. This present invention is referred to as the Global Health Information System (GHIS) and includes a global health information network which provides a platform for total healthcare information integration across the entire healthcare enterprise, both nationally and internationally.

Preferred embodiments of the present invention include a health information network that universally link hospitals, medical care facilities, home health agencies, clinics, nursing homes, hospices, residential treatment centers, laboratories, radiological practices, ambulance companies, medical group practices, health maintenance organizations, and pharmacies etc. (henceforth referred to as Healthcare Providing Institutions (HCPIs), individual physicians and allied health personnel (henceforth referred to as individual Healthcare Providers (HCPs)) and third party payers with day-to-day, real-time documentation of patient data via a computerized, web-based centralized data repository that is preferably accessible to the above, at all times, from any location, with patient consent and authorization.

While not being limited to a particular theory, the Global Health Information System includes two core components. The first core component is the centralized data repository, which serves as a centralized, computerized, interactive storage facility for patient information. The centralized data repository functions as the brain of the system. It also functions as a command center and interacts with patients, individual healthcare providers and healthcare providing institutions. The second core component is an Internal Data Management System, which is described in greater detail below.

Preferably, patients communicate directly with the centralized data repository for all of their interactions (e.g., initial patient registration, subsequent access to medical information). Individual healthcare providers also interact directly with the centralized data repository if they do not possess their own data management system. Institution-based healthcare providers can interact with the centralized data repository in at least one of two ways: firstly, through the Internal Data Management System—a web-based software application that is installed at the healthcare providing institution, or secondly, through the electronic medical record system currently used by the healthcare providing institution.

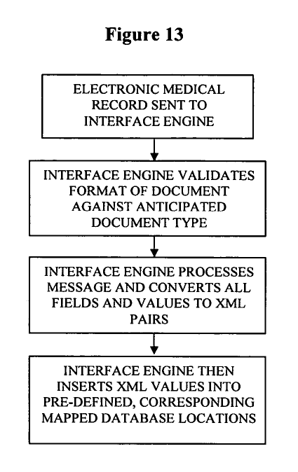

Records may be sent to the Global Health Information System from healthcare institution electronic medical record systems in several formats, for example, as shown in FIG. 13. Each format follows its own rules of exchange so that the validation methodology, format of the incoming message, and security measures vary for each type. For HL7 records specifically, electronic records are sent using a Lower Level Protocol (LLP). Flat files, received via a fax methodology (e.g., sent over a phone line) rely on government standard security rules in place for the protection of privacy over public electronic communication lines. Since data incoming to the Global Health Information System are planned communications, each incoming type of message has a planned XML format that it would be transformed into. Once converted to a standardized XML format by the interface engine, the document is then mapped to its database storage location using the interface engine's graphical user interface-based data mapping application. Any medical images (such as from a PACS application) received in an electronic medical record message are stripped from the message and stored in an extremely large data storage facility. The location, size, and other important identification information of the image are then written to the database, so as to have a way to relocate the image when it is requested by a user.

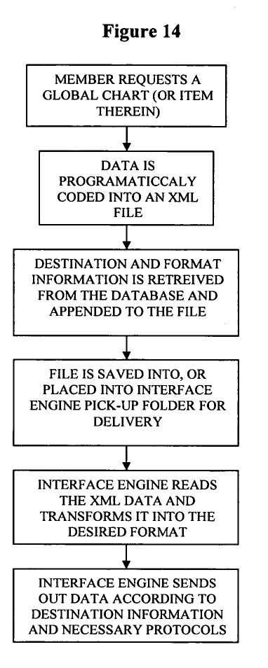

When a record is requested from the Global Health Information System (see FIG. 14 for example), the user specifies which format they would like to receive the message in (e.g., adobe acrobat, XML, flat file etc.). Different types of protocols are used for message relays to different entities. If it is a physician who is requesting the information to include into their local EMR system, then it is assumed that they have already signed up as a member of the system, either individually, or as a member of a healthcare service provider. When a physician signs up, the connections between the system interface engine servers and the physician's/institution's interface engine servers are established. This/these connection(s) is most likely in the format of an HL7 connection, but other formats are supported. Since each connection in a HL7 environment must be a TCP/IP (transmission control protocol/internet protocol) based pre-defined and persistent connection, each interface engine can only support a certain amount of defined connections due to limitations in computational ability.

The system interface engine, loaded on a cluster of Global Health Information System severs, is paired with reciprocal servers at participating healthcare institutions. Several institutional servers are linked to a single Global Health Information System server. The previously established connections between servers provide a portal for the bi-directional, targeted transfer of data. Further, as information is parsed out to individual institutional servers, tracking and auditing of this data is possible by matching the user of the data to an individual user account. Once known, the data requested from the Global Health Information System is programmatically queried from the systems specialized software and retrieved from the database, packaged with the known destination information, and then placed in the pick-up folder of the appropriate server. The interface itself handles the encoding between the formats and further handles the security and the auditing of the transaction process.

If the requesting entity is a physician who is not a member of an electronic medical record based entity but an otherwise authorized individual, then that person may choose a variety of formats to receive the documents, including, but not limited to, a .PDF file, a flat file, or just a plain .txt document. The destination, which may consist of a remote hard drive, fax machine, or other type of machine or location, will then be asked for from the user and the data requested will be programmatically retrieved and passed through the interface engine to be sent out.

All applicable protocols of transmission for the desired medium and destination will be controlled, executed, and audited by the capabilities of the interface engine. This is customized to the specific requirements of the system.

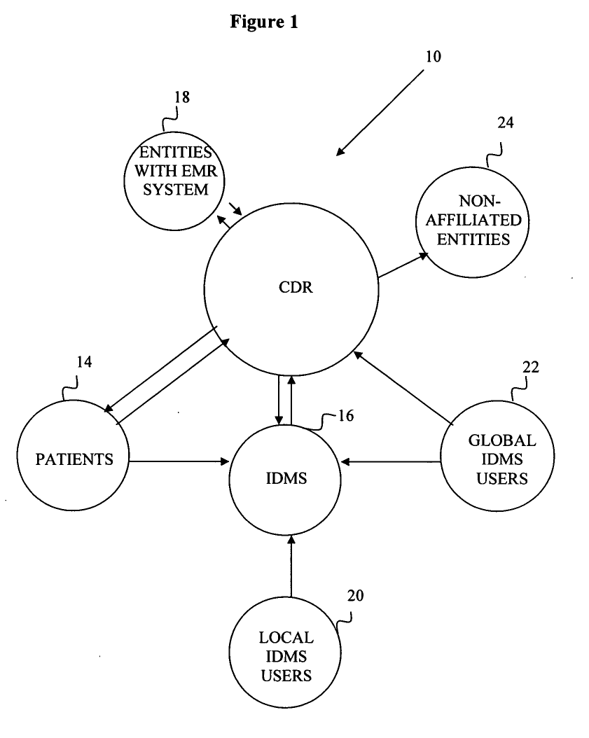

The overall architecture of a preferred embodiment of the present invention is described as Global Health Information System 10 in FIG. 1. A centralized data repository 12 is the nucleus of the Global Health Information System 10 and communicates with patients 14, Global Health Information System-Internal Data Management System(s) 16, electronic medical records systems 18, local Internal Data Management System users 20 and global Internal Data Management System user 22 (e.g., physicians) using the system remotely. In addition, non-member healthcare entities (e.g., non-affiliated entities 24) are able to download information stored in the centralized data repository 12 on specific request and after verification of their credentials, as will be described in greater detail below.

The centralized data repository 12 also controls identities (such as login, credentials, password, user accounts etc.) by creating unique System Identity Numbers for patients, healthcare providers and healthcare providing institutions as readily understood by a skilled artisan. An example of Global Health Information System unique identifier generation semantics is described below:

I. System Identity Number (SIN)
Comprised Of:
   1. Type Identifier:
      a. P->Patient
      b. D->Global Physician
      c. E->Entity
   2. Last three digits of year->2005=005
   3. Two digit month of year->03=03
   4. Two digit day of month->22=22
   5. Numeric increment padded to six digits->000006

Example:

| 1 | 2 | 3 | 4 | 5 | 6 | 7 | 8 | 9 | 10 | 11 | 12 | 13 | 14 |
|---|---|---|---|---|---|---|---|---|---|---|---|---|---|
| P | 0 | 0 | 5 | 0 | 3 | 2 | 2 | 0 | 0 | 0 | 0 | 0 | 6 |

Sum of all Parts Example: P0050322000006=14 character unique ID
Applies To:
   Patients
   Global Physicians
   Entities (Hospitals/HCPs)
   Global Charts (and the CDR)
   GHIS IDMS

II. Hospital Prefixes
Comprised of six characters that most closely represent the entity's name/acronym and can be reserved from the Patient/Global Physician username creation process. Disallows any Global Physician or Patient member from having a username beginning with a reserved acronym (e.g., UMHSMC). This first-come-first serve basis protects duplicate username identifications.
Example

University of Maryland Healthy System=UMHSMC

| 1 | 2 | 3 | 4 | 5 | 6 |
|---|---|---|---|---|---|
| U | M | H | S | M | C |

Notes:
   Entities will be given options if their first choice is taken.

III. Local User Accounts (Unique IDs for Tracking)
Comprised Of:
   1. Hospital Prefix->Ex-UMHSMC
   2. Last three digits of year->2005=005
   3. Numeric increment padded to five digits->00005

Example

| 1 | 2 | 3 | 4 | 5 | 6 | 7 | 8 | 9 | 10 | 11 | 12 | 13 | 14 |
|---|---|---|---|---|---|---|---|---|---|---|---|---|---|
| U | M | H | S | M | C | 0 | 0 | 5 | 0 | 0 | 0 | 0 | 5 |

Sum of All Parts Example: UMHSMC00500005=14 character unique ID
Applies To:
   1. Local (only) IDMS Users

IV. HEN->Health Encounter Number:
Comprised Of:
   1. Hospital Prefix->Ex-UMHSMC
   2. Last three digits of year->2005=005
   3. Two digit month of year->03=03
   4. Two digit day of month->22=22
   5. Numeric increment padded to five digits->00005

Example

| 1 | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|
| U | M | H | S | M | C | 0 | 0 | 5 | 0 | 3 | 0 | 0 | 0 | 0 | 5 |

Sum of all Parts Example: UMHSMC0050300005=16 character unique ID
Applies To:
   1. Patients at an IDMS enabled Health Care Institution
   2. Global Charts (for organization)

The System Identity Number is a 14-character number that is issued to only one patient and is destroyed or inactivated upon death of the patient. Unique identifying numbers based on this principle are also issued to global physicians, healthcare providers accessing the system from an Internal Data Management System (local user accounts), and healthcare providing institutions. The Health Encounter Number (HEN) is used as the unique identifying number for that specific hospital visit or encounter, acting as a file that stores all patient information generated during that hospital encounter under an IDMS-based system. While not being limited to a particular theory, a single Health Encounter Number is issued both for an individual encounter with an outpatient facility or with a healthcare providing institution visit that involves admission to that facility. The System Identity Number is the unique identifier number for the entire system and helps link different Health Encounter Numbers together at the centralized data repository and Internal Data Management System level. Information contained within a Health Encounter Number (tagged by the System Identity Number) and relevant for entry into the centralized data repository is uploaded into the centralized data repository. At the Internal Data Management System level, different Health Encounter Numbers are also organized and stored via recognition through a common System Identity Number. Thus locally generated patient information becomes globally available, matched by the System Identity Number once uploaded into the centralized data repository. Health Encounter Numbers are thus encounter, transaction or admission specific and System Identity Numbers are patient specific.

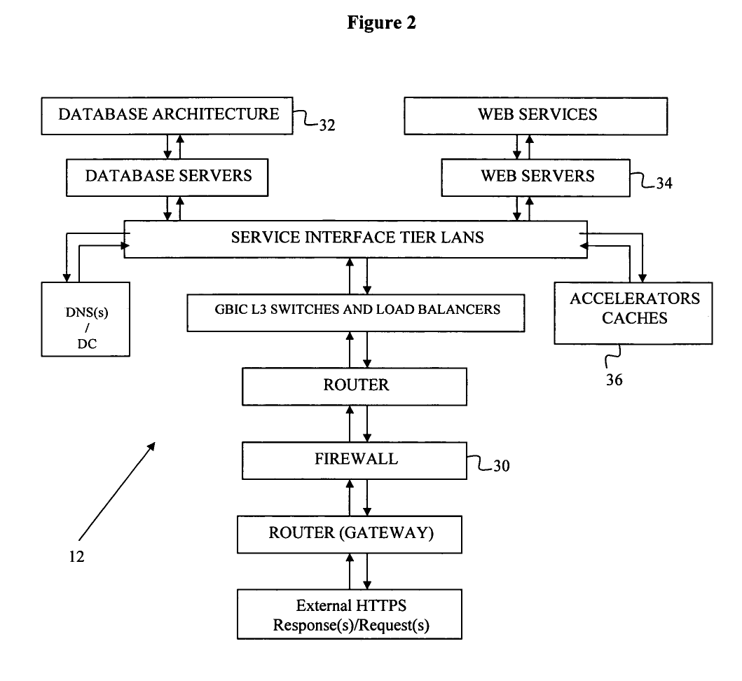

FIG. 2 shows an exemplary flowchart that describes the architecture of the centralized data repository 12 shown in FIG. 1. As can be seen in FIG. 2, the centralized data repository 12 includes but is not limited to an external interface (security and routing), internal connections, database and web server clusters.

While not being limited to a particular theory, all connections to the centralized data repository 12 are preferably filtered through an external firewall and more will be added as bandwidth requirements increase. This will be the first and primary level of security for the centralized data repository 12. Once on the internal network, which is likely gigabit Fiber Optics, the data is routed to the appropriate section. See FIGS. 15 and 16 for exemplary displays (e.g., website pages) of interaction with a user (e.g., entity, patient, physician). Health Level Seven or another Electronic Data Transmission Standard (EDTS) records will be processed in a series of applications in order to prevent bottlenecking of the synchronization process. Once fully verified and processed, electronic data transmission standard records will be added to a database 32. Web server(s) 34 will handle the external data requests from global physicians, Internal Data Management System users and patients using caches and accelerators 36 as desired to reduce the request time. Developer and database administrator PCs will also form part of the network which will be housed at the corporate offices in order to allow adjustments and updates to be made to the database 32, the web server(s) 34, and to applications processing the electronic data transmission standard records. The Domain Name Server (DNS) holds the English name to numeric IP addresses on a network and the Domain Controller (DC) serves as a network routing device.

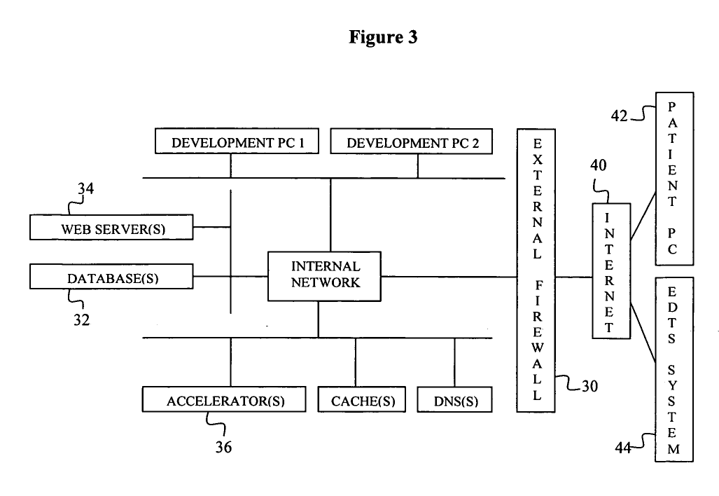

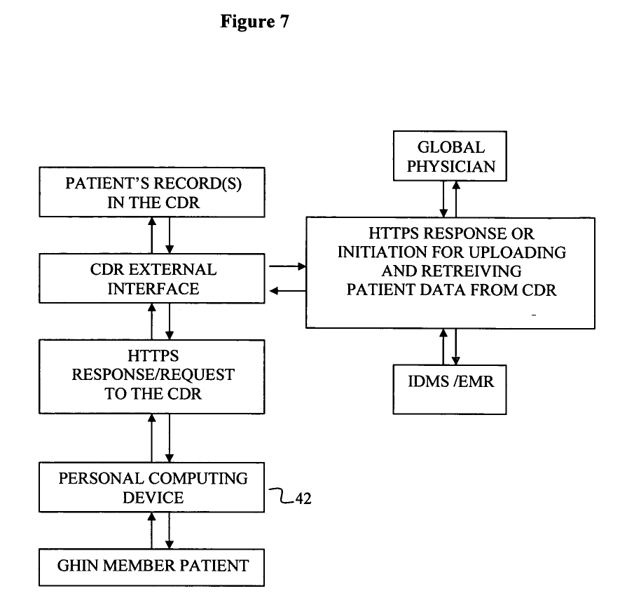

FIG. 3 shows a more detailed exemplary architecture of the centralized data repository 12. While not being limited to a particular theory, the centralized data repository 12 includes two major interfaces to the Internet (FIG. 7). The first interface is for Patients 46 using the system (e.g., via patient PC 42) to view and manage their records via a secure connection (e.g., HTTPS 128-bit), and the second interface is for an electronic data transmission standard system (EDTS) 44 that is capable of sending records to or receiving records from the centralized data repository 12 in order to facilitate data management and patient care. The EDTS is tied to certain well-defined triggers that facilitate the timing of data transfer. A trigger is a defined event, for example, a certain time of day or the occurrence of specific tests etc. This would result in the compilation of medical data bearing messages to be transferred to the system. The centralized data repository 12 stores the core patient-related data needed to provide optimal, efficient and immediate care to patients. This core information is called the patients' Global Chart. The centralized data repository 12 includes a central repository for all Global Chart worthy information. The worthy information is included in a defined standard set of data that facilitates patient care across multiple healthcare institutions. The data set forms the core elements of the Global Chart. Examples of this include, but are not limited to, history and physical examination notes, consult notes, all laboratory and radiological data etc.

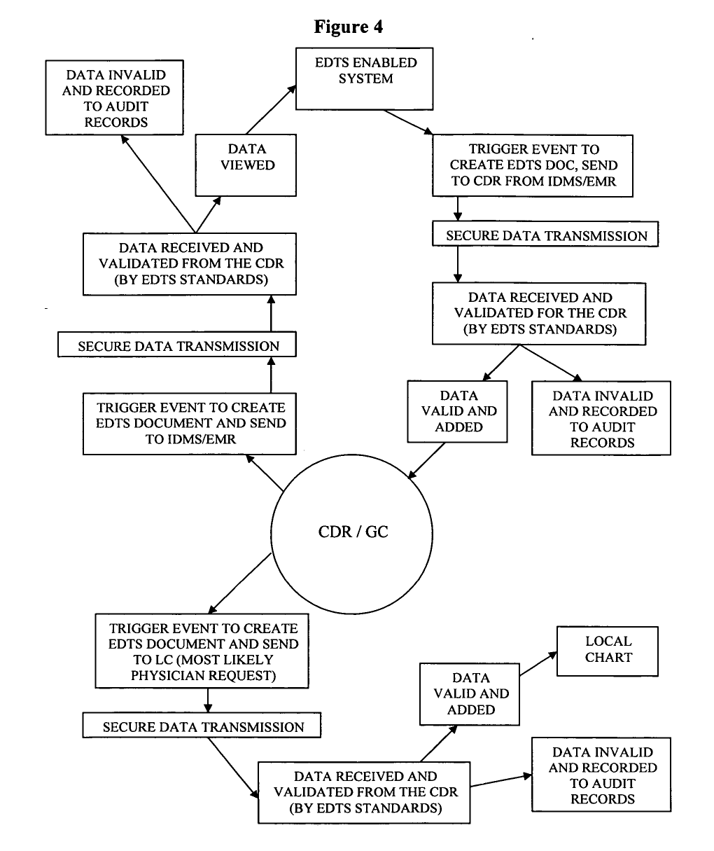

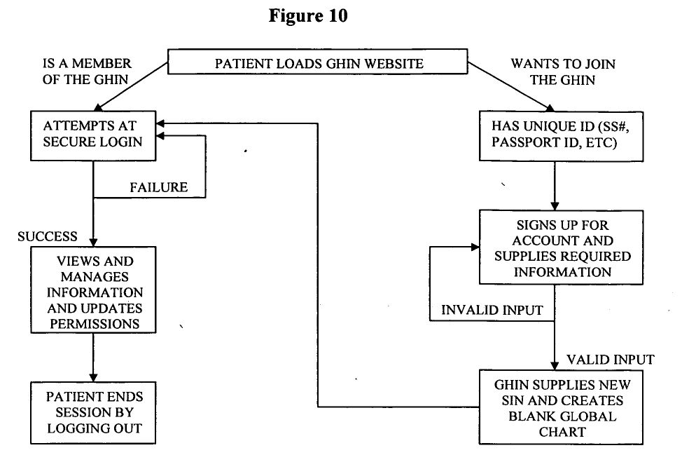

While not being limited to a particular theory, Global Chart data can be entered into the centralized data repository 12 in two ways. Either patients can create their own Global Health Information System account and enter in/upload information into their Global Chart to be used later by a physician (see FIG. 10), or the Global Chart can be created automatically from a system Internal Data Management System or other Global Health Information System-affiliated electronic medical record system (see FIG. 4). If the Global Chart is created by an entity other than the patient, the patient must provide identity verification in order to gain access to the Global Chart. Regardless of patient access to the Global Chart, if a Unique Patient Identifier is available, the patient Global Health Information System account generates a System Identity Number, which is a preferred approach for identifying Global Charts. While not being limited to a particular theory, to help maintain confidentiality of patient-sensitive information, healthcare providers or healthcare providing institutions wishing to access data in the Global Chart must have permission from the patient to do so. Thus, irrespective of who owns (i.e. created) the Global Chart, access to patient-sensitive information must be provided by the patient.

FIG. 4 shows an exemplary approach to how data enters the Global Chart from a healthcare institution's data management system. If the affiliated healthcare providing institution is using a Global Health Information System-Internal Data Management System, then the healthcare providing institution's data is synchronized with the centralized data repository 12 on a scheduled basis using the associated electronic data transmission standard. Non-Internal Data Management System, but affiliated healthcare providing institutions using their own electronic medical record system can upload electronic data transmission standard-encoded documents to the centralized data repository 12 on a trigger basis. They type of EDTA standard involved will be predetermined when connections are set up between system and institutional servers and the Global Health Information System would be able to accept that particular standard and convert it into an XML format. Triggers are events in the treatment of a patient that constitute a need to update the Global Chart with new information that will later be helpful to other physicians. Triggers can include, but are not limited to a new prescription, new lab results, new sets of radiology images, a certain set time, etc. After the centralized data repository 12 has created an initial patient account and designated a System Identity Number to the patient, all future data uploaded to the centralized data repository for that patient is automatically appended to the patient's Global Chart by using unique identifiers (e.g., System Identity Numbers).

The Global Chart includes information and data that would be helpful to patients, healthcare providers, and healthcare providing institutions. Member patients with access to the Global Chart can be kept abreast of their significant physician contacts, laboratory and radiological information. These member patients preferably have access to this information from any location (e.g., local, remote) and at anytime. Member healthcare providers and healthcare providing institutions have the advantage of instantaneous access to the patient's complete medical history. Tests performed recently, but not accessible with the current, fragmented system of medical information documentation, storage and retrieval can now be readily available-resulting in cost savings and reducing the need to duplicate costly, sometimes invasive tests.

In emergency situations, the patient's health history can readily be available, no matter where the patient received prior medical care. With the preferred embodiments of the invention, there should be no geographic, institutional, or technical delays in obtaining such often life-saving information. Further, patients would not have to repeatedly fill multiple similar forms at different healthcare provider offices, documenting the same information several times. Moreover, second opinions can easily be obtained by allowing remote physician assess to the Global Chart. Specifically, the Global Chart would preferably include, but not be limited to personal profile and insurance information, history and physical examination data, consultation notes, discharge summaries, laboratory data, radiological data, allergy information, etc.

With the preferred embodiments of the global health information system, the Global Chart is constantly updated. However, while not being limited to a particular theory, the Global Chart preferably does not store detailed, day-to-day, hospital-specific information that adds little to patient care. This detailed, day-to-day information is instead preferably stored in the Local Chart (LC), an Internal Data Management System specific entity, or the electronic medical record system as desired for the application. The Local Chart will contain all information about a patient at a specific entity and contain all information entered into the system by healthcare providers while the patient is at that healthcare providing institution. Not all of this data is necessary for the Global Chart, and as such, only information useful to the patient's care, as understood by a physician, is packaged for synchronization with the Global Chart. This unique feature allows separation of important patient data from unimportant, healthcare providing institution-specific information not useful for patient care, providing healthcare providing institutions with a level of internal privacy.

Under an IDMS-based system, a unique identifier called a Health Encounter Number ties local chart records together. Preferably this unique identifier is logically created by using an entity prefix plus an encounter number, for example, as described earlier. This identifier ensures a unique Health Encounter Number for each encounter not only at the local level, but also at the centralized data repository level. All Health Encounter Numbers can be tied together at the centralized data repository level by the System Identity Number. As a part of the Internal Data Management System, the Local Chart is available for remote access by global physicians through a secure connection. As global physicians add/update their data, the new data is saved locally for packaging and synchronization at a later time with the centralized data repository or Global Chart. Local users, or those that don't require remote access (e.g. nurses, other allied heath staff, clerical staff) can work only with the Local Chart, and have security-based permissions that control aspects of the Local Chart they have access to. While not being limited to a particular theory, an electronic medical record system does not have Global Health Information System-generated Health Encounter Numbers, but typically would use their own system specific medical record numbers. However, electronic medical record-central data repository interface preferably requires a System Identity Number for matching.

While the present invention also provides a data management system in the form of the Internal Data Management System that is web-based and hence accessible remotely, it allows healthcare providing institutions already processing an electronic medical record system (that is not usually web-based and has limited remote access) and not wishing to acquire a Global Health Information System-Internal Data Management System, to continue to use their electronic medical records system as before. A specialized software program allows electronic medical record interface with the centralized data repository and access to the Global Chart, as understood by a skilled artisan. This is made possible by a system of linked servers, a customized interface engine and customized software. This unique methodology and design structure allows mapping source and destination data fields together and subsequently transforming the document into the specified format to support such mappings. The formats themselves are defined by the groups who develop them, for example, HL7. Contractual agreements with member institutions allow the exchange of data and the software maps each entities data graphically. This unique design allows generic EMR systems to have bi-directional exchange of data with the Global Health Information System, thereby allowing the present invention to be all-inclusive.

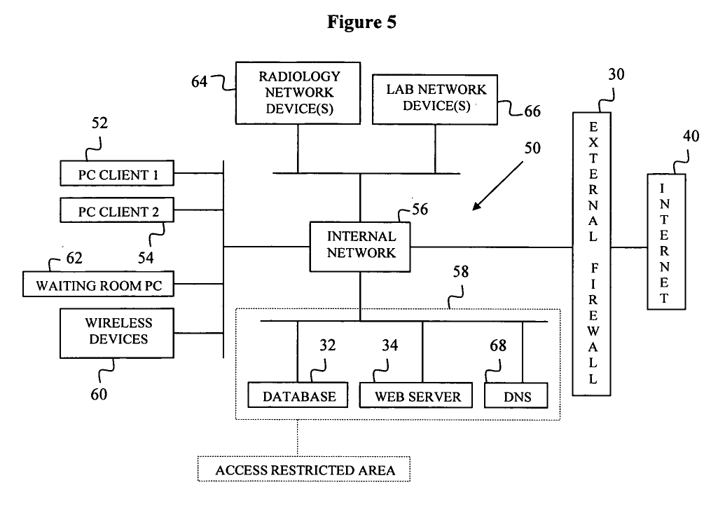

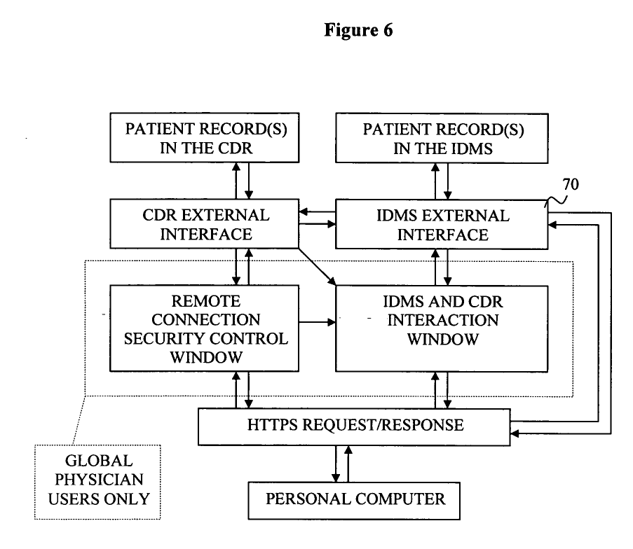

The second core component of the Global Health Information System is the Internal Data Management System, which is the day-to-day web based software for all healthcare providing institution employees. While not being limited to a particular theory, the Internal Data Management System is implemented through the internal network, with an external interface 70 for global physicians (FIG. 6). The architecture of the Internal Data Management System 50 is shown, for example, in FIG. 5 and includes a web server 34, a database 32, and the required PCs 52, 54 and network infrastructure 56 to support such a distributed system. An audit log tracks each user's interactions with the server, and the hardware of the web server and database is preferably located in a restricted access area 58 on the premises (FIG. 5). Local Charts reside on an entity's Internal Data Management System and have entity specific logins for local Internal Data Management System users. The Internal Data Management System allows a global physician to use their single login as well. Account creation for global physicians preferably occurs at the centralized data repository level and is typically downloaded and activated on the Internal Data Management System 50 by an Internal Data Management System administrator. It is understood that the Internal Data Management System can be one system or a plurality of data management systems.

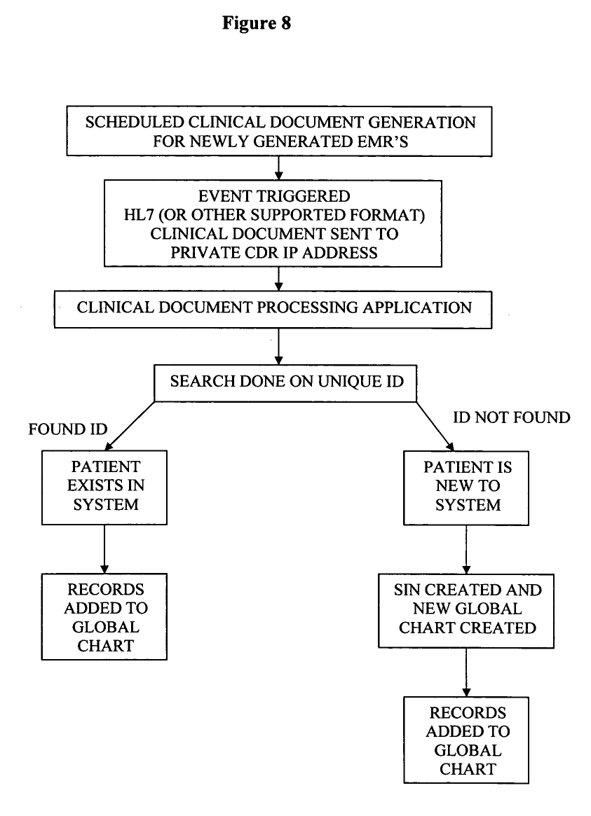

While not being limited to a particular theory, the Internal Data Management System(s) 50 preferably packages the data collected each day (that is applicable for the Global Chart) during a scheduled off-usage time. This is shown in FIG. 8. The aggregated data is packed using the electronic data transmission standard, and is sent to the centralized data repository for processing and synchronization with existing Global Chart accounts or creating new accounts as necessary. This arrangement reduces the systems reliance on a continuous, high-speed Internet connection for critical patient-care data and data management overall, because the Internal Data Management System is a local entity.

FIG. 5 describes further details of the preferred Internal Data Management System architecture. The Internal Data Management System 50 is interfaced to the Internet 40 through a firewall 30. This firewall 30 filters the Internet connections and provides an external security system. Once inside the internal network 56, the Internal Data Management System 50 includes three major components. Physician and patient interfaces (e.g., desktop PC 52, 54, handheld computer, kiosk, wireless devices 60, waiting room PCs 62) connect the user to the entity's internal network 56. The wiring is preferably provided through a wireless access point/router or an Ethernet cable (e.g., CAT5 10/100). Other major internal components include a radiology network device 64 or a laboratory network device 66 (see FIG. 5). These components transfer their data to the Internal Data Management System 50 under standards (e.g., DICOM) via an internal Ethernet structure (e.g., CAT5 Ethernet) as understood by a skilled artisan. It is understood that for more intensely used networks, a Fiber-Optic internal network may be a preferred alternative.

Still referring to FIG. 5, on the controller end of the Internal Data Management System 50, in the restricted access area 58 resides the web server 34 to serve the web application, the database 32 to hold the data and provide auditing services, and a Domain Name Server (DNS) 68 to control network connections.

In special circumstances and as an added feature, the Internal Data Management System 50 has the ability to store parts of the Global Chart within its database for ease of access to frequently referenced information (e.g., radiological data). However, this is not a frequent occurrence, since the vast majority of the Global Charts are stored only in the centralized data repository 12, with the local Internal Data Management System/electronic medical record systems having access to the Global Charts as needed.

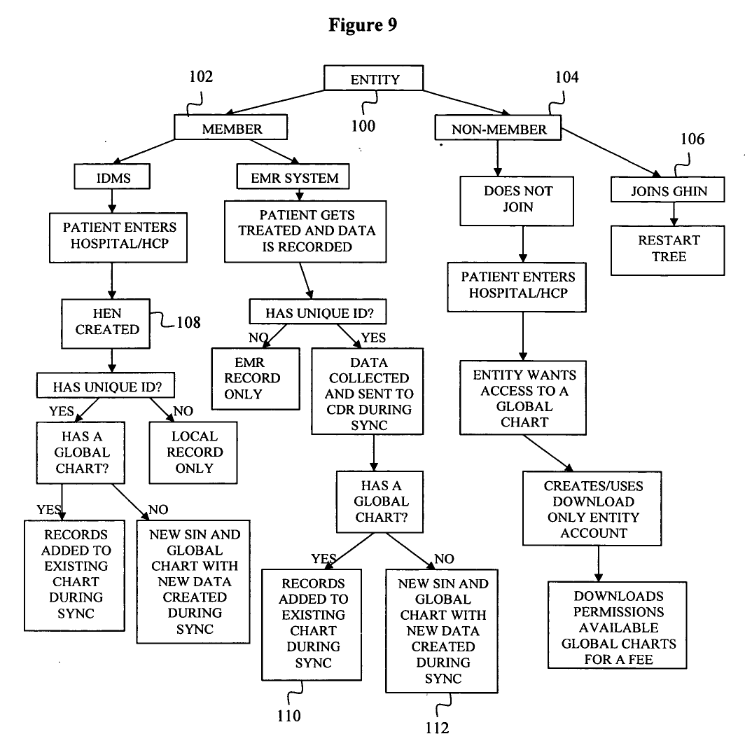

FIG. 9 shows healthcare providing institution (e.g., Entity 100) interaction with the Global Health Information System 10 via either an Internal Data Management System or electronic medical record system (assuming an Internet connection). The centralized data repository 12 either recognizes the patient (e.g., member patient 102) or does not recognize the patient (e.g., non-member patient 104). Member patients have an existing Global Chart and their information is verified. Non-member patients are entered/registered into the system and a new Global Chart is created at 106. The patient must provide some personal information (e.g., his/her name, address, date and place of birth, social security number and mother's maiden name) to allow verification or registration. Children without a social security number of their own can be registered/verified using their parents' social security number or other information on the child's birth certificate. Individuals without a social security number are registered/verified with other unique identification, for example, with a passport number or a national identity number. The centralized data repository 12 searches its database and matches the unique identification with those in its database. If no match is found, the entry is noted as new and a new Global Chart can be created. For healthcare providing institutions with an Internal Data Management System, a System Identity Number is also issued by the centralized data repository. The Internal Data Management System then creates a health encounter number at 108, which serves as a file storing all patient data generated during that patient encounter. If a social security number or passport match is found, a Global Chart and System Identity Number already exist for that patient and new ones are not created.

For healthcare providing institutions with an electronic medical record software system, data is packaged into electronic, transferable clinical data documents. These documents are then sent to the centralized data repository 12 for addition into the repository defined by set trigger events. The unique identification sent with the data, for example, the patient's social security number, is then matched against existing records. If the patient record exists, the data is added to the Global Chart at 110. If the patient is new, a new System Identity Number and Global Chart are created for that patient and new data is appended at 112. Information relevant for inclusion in the Global Chart is uploaded into the centralized data repository at regular intervals. Information not directly related to patient care and used primarily by healthcare providers or healthcare providing institutions to document internal processes and indices is stored only in that entities' Internal Data Management System or electronic medical record.

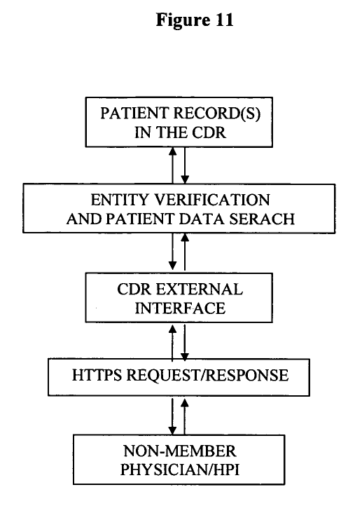

Still referring to FIG. 9, non-member healthcare providing institutions are able to download the Global Chart of member patients upon patient request and authorization at 112. This is also shown, by example, in FIG. 11. This information would be made available to the non-member healthcare providing institutions on an electronic documentation file (e.g., .PDF) via a one-time password. There would typically be a per-download fee for non-member healthcare providing institutions/healthcare providers for this service.

FIG. 10 shows an example of patient interaction with the Global Health Information System. Under the preferred embodiments, patients can view their complete medical information on-line, at all times and from any location. Specifically, patients would have the ability to enter their personal and contact information, presenting complaints, history of presenting complaints, review of systems, past medical and surgical history, medications, allergies, family and social history and all similar information either on-line from the convenience of their homes or from physician waiting rooms. This method of data input from the patient increases the accuracy and completeness of the patients' history and saves considerable physician/healthcare provider time. The physician/healthcare provider corroborates the information entered by the patient, and adds his/her own notes to the history and physical examination form. Healthcare providers are thus able to spend the maximum amount of time focusing on the relevant parts of the patient's history and performing complete physical examinations, rather than spend most of their time in documentation. In other words, healthcare provider time is transferred from documentation effort to patient care, which allows for a far more efficient and productive patient/physician interaction.

The present invention allows patients to view their medical information, fill forms required by healthcare providers and healthcare providing institutions they plan to visit in advance and authorize access to their Global Chart. Global transfer of information between different healthcare providing institutions and healthcare providers can only occur if the patients provide authorization and consent; done by the patients themselves on-line or on the telephone, or by the signing of a release at the time of presentation to a healthcare provider or healthcare providing institution.

The process of initial registration by patients is performed on-line or on the telephone. While not being limited to a particular theory, the patient's personal or biographical information (e.g., name, address, date and place of birth and social security number) must be provided to access the system. For added security, information that the patient should know but is not generally available with the patient's biographical information (e.g., mother's maiden name, favorite color, pet's name) is also noted. Children without a social security number of their own are registered using either their parents' social security number or their birth certificate. Individuals without a social security number will be registered with a passport number. In other countries, the state issued nation identity number can be used in place of the social security number. The goal is to register every individual with a verifiable identity code (e.g., social security number, national identity number) as the case may be. Patients initially registered with a number other than their social security number and wishing to change to their social security number would preferably have to provide extensive documentation to do so. This information, once provided, will allow the centralized data repository to generate a Global Chart and new System Identity Number for the patient.

After registration is completed, patients can log-on to the system, preferably by entering their specific ID and password. This allows them access to their Global Chart. Patients also have the ability to allow access to their Global Chart to specific healthcare providers and healthcare providing institutions, allowing them access to their medical information in advance of the actual patient/healthcare provider encounter. Moreover, patients also have the ability to add healthcare providers and healthcare providing institutions to a list of entities with access to their Global Chart. In addition, upon logging-on to the system of the preferred embodiments, patients can identify all entities that have accessed their Global Chart. This allows complete monitoring and dynamic control of traffic through the Global Chart. Undesirable traffic can be immediately suspended and access blocked.

Patient encounters with outpatient clinics, radiology, laboratory, physical therapy or pharmacy services similarly generate a new Global Chart, System Identity Number and Health Encounter Number for new patients and only a Health Encounter Number for patients already having a Global Chart in the system.

It is understood that in emergency, life-threatening situations, a social security number, passport number or patient identification may not be available to the healthcare providing institution or healthcare provider. In those instances, the Internal Data Management System provides the hospital or healthcare provider with a Health Encounter Number but not a System Identity Number (which is only issued by the centralized data repository). Healthcare providing institutions are then able to enter patient information as usual into their local Internal Data Management System using an alias and the Health Encounter Number. However, this information is not uploaded into the centralized data repository (since it is not tagged with a System Identity Number). If the patient is identified during their hospital visit and a social security number obtained, then a new Global Chart and System Identity Number are issued for new patients or a previously issued System Identity Number verified for member patients. The System Identity Number allows data transfer, synchronization and storage at the centralized data repository as needed. In similar instances, verification by social security number would occur for healthcare providing institutions with existing electronic medical record systems.

Healthcare providers would have the option to initially store their entered data on the system Internal Data Management System as preliminary documents. Preliminary documents are available for viewing on the Internal Data Management System, but not on the centralized data repository. Once finalized by the relevant healthcare provider, the information is converted to permanent status, where it would then become available on the centralized data repository and become an indelible part of the patient record. This added feature allows addendums and additions to be made as notes to the patient record during the course of the day. However, notes must be finalized or released within a specified time period.

Another added feature of the present invention is the ability to provide either generic or customized forms to healthcare providers and healthcare providing institutions. Specifically, forms such as history and physical examination, consult notes, progress notes, nurse's notes, preoperative check notes, and all allied heath care and related notes would be available in a generic or customized format unique to the healthcare provider or hospital. Forms would be customized to reflect the appropriate healthcare provider or hospital, including logos, addresses, contact numbers, customized signatures, etc, as readily understood by a skilled artisan.

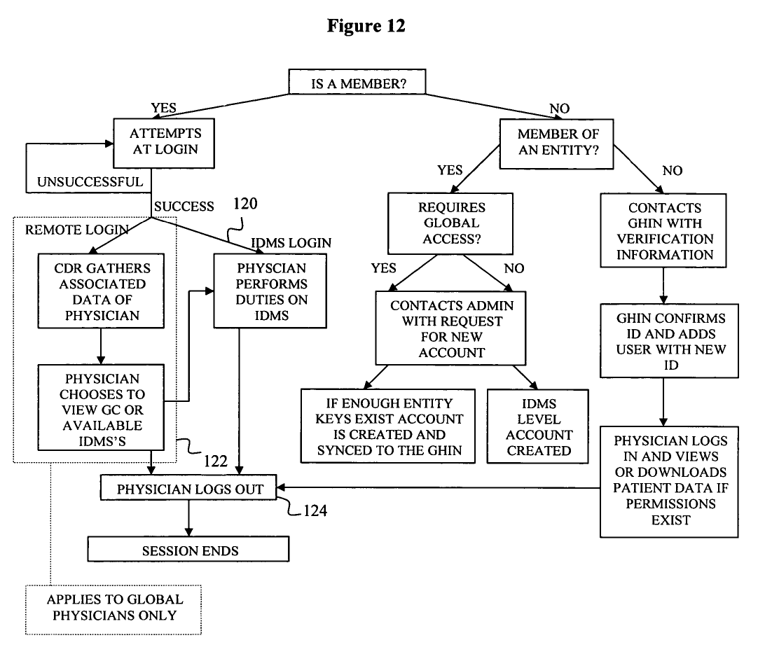

FIG. 12 shows an exemplary physician interaction with the Global Health Information System. In this interaction, individual healthcare providers log-on to the system at the centralized data repository level and have access to the Global Chart. This group includes solo practitioners, individual practitioners in small groups etc. In this preferred embodiment, the individual healthcare provider registers directly with the centralized data repository, and no additional software is required since the system is web-based and functions using web browsers. At the Internal Data Management System level, the system would preferably only allow healthcare providers and hospital personnel access to specific areas of the Global Chart and Local Chart commensurate with their level of security clearance. This restricted system of access allows the global sharing of patient information without compromising specific and sensitive patient, healthcare provider or hospital-related information. Physicians that are part of a group or hospital are registered with the centralized data repository through their local hospital administrator. The physicians are issued a User ID, Password, and a note made of their Internal Data Management System (healthcare providing institution) associations. Upon logging-on to the system from a local Internal Data Management System at 120, the group or hospital physician has access to all data stored in the Internal Data Management System regarding patients they are involved with. Specifically, they would have the option to see a list of patients they had contact with (e.g., consulted on, treated, operated on etc.) in the last 1, 3, 7, 30 days etc. This feature is customizable per physician preference. The logged-in physician also has the ability to access the Global Chart of any of these touched patents as needed. Further, the logged-in physician would preferably also be provided with a list of Internal Data Management System(s) where they have credentials and would in similar fashion be able to view all relevant patients at those Internal Data Management System(s).

When physicians sign on from outside an Internal Data Management System network at 122, for example, remotely from another location or home, they will be presented with a list of the Internal Data Management System(s) where they are credentialed and they would have the ability to access patients at anyone of the Internal Data Management System(s). With this feature physicians are able to utilize one user ID and password in order to view/enter data on their patients across several institutions and entities from either an Internal Data Management System or remotely. Healthcare providers other than physicians do not generally need remote access to patient information. Instead, these healthcare providers are issued institution or entity specific-intelligence coded IDs and personal passwords. While not being limited to a particular theory, this hospital group ID is intelligence-coded, hence allowing differing levels of access to the Local Chart and Global Chart, as well as tracking information. Upon the healthcare providers leaving or disassociation with that entity at 124, access to the Internal Data Management System is suspended. Access to the Global Chart by physicians affiliated with healthcare providing institutions having their own electronic medical record software as opposed to the Internal Data Management System setup occurs via a secure, certified high-speed Internet connection (e.g., 128-bit SSL). Remote access to the Global Chart is dependent on the specifications of that particular software. However, if they have patients in other healthcare providing institutions with different electronic medical record software, then they would either have to log-on physically at that location (as is currently the case in most instances) or remotely if possible. In both instances, a separate ID and password is needed for access to each system. Hence the advantage of an Internal Data Management System as compared to an electronic medical record system is interconnectivity at all levels, with the ability to access all necessary information through one system and one ID/password log-on.

Further tracking of users is achieved by placing database audit software and file auditing software on each hospital's or healthcare provider's Internal Data Management System in order to provide the highest level of data integrity and accountability.

Once all healthcare providing institutions adopt the Internal Data Management System of the preferred embodiments, the Global Health Information System would ultimately eliminate the need for multiple software packages and software updates, system. While not being limited to a particular theory, the Global Health Information System provides a single platform for the acquisition, storage and global dispensation of medical information with multiple points of data input-all under patient authorization and control. Physicians would ultimately access the entire system from any location with one ID and password.

The Global Health Information System eliminates a major hurdle of data mapping amongst several different Electronic Medical Record (EMR) systems, as all mapping occurs de novo within the system. For example, the preferred Global Health Information System identifies different types/formats of text data coming into the system from different EMR sources by attaching a meta class id for each data format (history and physical notes, consult notes, progress notes etc.), in addition to the meta class id for the EMR system type. This means that the Global Health Information System is not limited in trying to accommodate certain format types, as formats for history and physical notes, consult notes, progress notes etc can be very variable. Having two meta class flags adds an additional layer of flexibility to the system. Secondly, when a record comes into the Global Health Information System, it can be saved in any database format required, and then reconstructed for display on the Internet by combining the unique record id, and its format type.

The Global Health Information System connects various EMR systems, preferably by using a series of record type identification identifiers and meta class flags on each lookup table of the centralized data repository. While not being limited to a particular theory, a lookup table typically used for this purpose includes an “ID” and “Description” pair for all medical terms. An example of this ID/Description pair is “DA”/“DIABETES”, where DA is the ID or shorthand form of the term or description Diabetes. In addition to this ID/Description configuration, each lookup table includes a record type Id. Each record type Id (or identification) corresponds to the type of EMR system that submitted the record. Thus, for example, if the Global Health Information System were to receive a medical record from the “Cerner” EMR system, the GHIS would flag its corresponding ID/Description pair with a record type Id of, for example, “C” for “Cerner”. Hence the term “Diabetes” is tagged as: C; DA; DIABETES. In this way, regardless of whether or not the Global Health Information System recognizes a medical term in the same way as another system, it has the ability to accept the data and store it. The meta class flags are then used later on when a person whom is deemed knowledgeable in medical terminology matches a random party's EMR system's terminology with that used by the Global Health Information System. In this way, the Global Health Information System has the ability to “inherit” unfamiliar terminology and assimilate it into its database for future recognition.

A full-bodied example of this is if the Global Health Information System receives a medical descriptor in the ID/Descriptor pair of “DI”/“Diabetes” and the Global Health Information System previously defined this as “DA”/“Diabetes”. A known system would not logically map these two values as the same due to obvious discrepancies in their ID. However, the medical terminology specialist could then update the meta class flag of the “DI”/“Diabetes” to “DA”, so that when presentation is performed online, only the Global Health Information System ID/Descriptor is used, instead of a redundant display of both. If the Global Health Information System does not have a matching ID/Descriptor, that is, a new terminology for the system, then the Global Health Information System adds the new terminology into its system.

The Global Health Information System will provide a completely dynamic model of incorporating incoming text data from submitting healthcare providing institutions. Data will come to the Global Health Information System in the format of medical record templates, or formats. Examples of these formats include, but are not limited to, History and Physical Records, Medication Records, Progress Notes, and Consultation Notes. When these documents are sent to the Global Health Information System, the template or data format model that they are comprised of will be recorded in a meta class field when they are saved. This meta class field will exist in all tables where data incoming from healthcare providing institutions will be saved. It will contain the ID value of the type of format the data is coming from.

An example of this would be if the Global Health Information System were to receive a Consultation Note from the EMR system “Cerner”. The format meta class associated with Consultation Notes and saved by the database would be “CN”, as to allow the system to know that all saved records in this set were part of a Consultation Note; and the record type meta class would be saved with a “C” for “Cerner” as noted above. Then, a few seconds later for example, another Consultation Note arrives from the EMR system “IDX”. This second Consultation Note, while having a completely different format yet similar data, is easily added into the system network of predefined values, and appended with “CN” for it's format meta class, and “IDX” for it's record type meta class.

The Global Health Information System also provides an approach for providing a method of automatically populating the requesting physician's EMR system with specific parts of the Global Chart. For example, when an EMR-based hospital (e.g., one using “Cerner”) wants to download a record from the Global Chart, the Global Health Information System uses the hospital's preferred terminology by matching the record type Id value assigned to that hospital in another database table, and matching it to the corresponding record type Id in the lookup tables.

While not being limited to a particular theory, the Global Health Information System may be available in several languages, specifically, but not limited to English, Spanish, German, Italian, and French etc. The Global Health Information System also has the ability to interface with voice recognition software.

The Global Health Information System allows patients to constantly and instantaneously monitor all their health information and data. Uniquely, this method of data upkeep and compilation occurs seamlessly and with minimal effort on the patients' part due to the design architecture described above.

The Global Health Information System is highly modularized, allowing custom-built features to be easily added for add-value implementation and user demand. It will also allow for quick adjustments to comply with Health Insurance Portability and Accountability Act (HIPAA) regulations of security and privacy, and any further regulations imposed on a country-by-country basis as necessary.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention. Without further elaboration the foregoing will so fully illustrate the invention that others may, by applying current or future knowledge, readily adapt the same for use under various conditions of service.

What is claimed is:

1. A method of providing healthcare information integration between a plurality of healthcare providing institutions, individual healthcare providers and patients via a web-based network having a centralized data repository accessible to the healthcare providing institutions, individual healthcare providers and patients, each of the plurality of healthcare providing institutions using a respective electronic medical record system that may be different in format than other electronic medical record systems, the method comprising:
accepting electronic patient medical record data having a plurality of formats from a plurality of electronic medical record systems into the centralized data repository;
converting the accepted electronic patient medical record data into a format familiar to the network using a data mapping application to create a converted electronic patient medical record data corresponding to the accepted electronic patient medical record data;
storing the converted electronic patient medical record data into the centralized data repository;
identifying one of the plurality of healthcare providing institutions, individual healthcare providers or patients requesting the stored electronic patient medical record data via the network;
transforming the requested electronic patient medical record data into a format specified by the one of the plurality of healthcare providing institutions, individual healthcare providers or patients requesting the stored electronic patient medical record data; and
delivering the transformed electronic patient medical record data to the one of the plurality of healthcare providing institutions, individual healthcare providers or patients.

2. The method of claim 1, further comprising mapping healthcare images from a plurality of healthcare providing institutions into the centralized data repository as part of the electronic patient medical record data.

3. The method of claim 1, further comprising controlling identities of the healthcare providing institutions, individual healthcare providers and patients by creating a system identity number that is unique for each of the healthcare providing institutions and individual healthcare providers that are accessing the network and for each patient having electronic medical record data in the centralized data repository, and storing a respective system identity number with each record of the electronic medical record data.

4. The method of claim 3, further comprising tagging patient healthcare activity by creating a health encounter number for each patient visit to a healthcare providing institution or individual healthcare provider, and storing the health encounter number with the electronic patient medical record data associated with the patient visit into the centralized data repository.

5. The method of claim 4, wherein the step of storing the converted electronic patient medical record data into the centralized data repository includes mapping each record of the electronic medical record data in accordance with the system identity number and health encounter number.

6. The method of claim 1, further comprising assimilating and identifying terminology from a specific electronic patient medical record data by providing a lookup table having a record type identification corresponding to each type of electronic medical record system that submitted any of the electronic patient medical record data.

7. The method of claim 6, said lookup table provided by the step of assimilating terminology further including meta class flags corresponding to respective medical term identifications and descriptions for medical terms used by the network and other electronic medical record systems in integrating healthcare information from the plurality of healthcare providing institutions and individual healthcare providers.

8. The method of claim 7, wherein the step of assimilating terminology from the electronic patient medical record data local to the entity into the network further includes updating the meta class flag of any of the respective medical term identification and description by matching associated medical term identifications and descriptions.

9. The method of claim 1, further comprising accessing the electronic patient medical record data, storing core patient data needed for patient care from the electronic patient medical record data into a global chart of the centralized data repository, filtering extraneous information that is valuable only to the healthcare providing institution that created the accessed electronic patient medical record data, and storing the filtered extraneous information in the centralized data repository separate from the global chart.

10. The method of claim 9, further comprising automatically populating one of the plurality of electronic medical record systems with the core patient data of a patient referenced by any of the plurality of healthcare providing institutions or individual healthcare providers.

11. A system for providing healthcare information integration between a plurality of healthcare providing institutions, individual healthcare providers and patients via a web-based network having a centralized data repository accessible to the healthcare providing institutions, individual healthcare providers and patients, each of the plurality of healthcare providing institutions using a respective electronic medical record system that may be different in format than other electronic medical record systems, the system comprising:
means for accepting electronic patient medical record data having a plurality of formats from a plurality of electronic medical record systems into the centralized data repository;
means for converting the accepted electronic patient medical record data into a format familiar to the network using a data mapping application to create a converted electronic patient medical record data corresponding to the accepted electronic patient medical record data;
means for storing the converted electronic patient medical record data into the centralized data repository;
means for identifying one of the plurality of healthcare providing institutions, individual healthcare providers or patients requesting the stored electronic patient medical record data via the network;
means for transforming the requested electronic patient medical record data into a format specified by the one of the plurality of healthcare providing institutions, individual healthcare providers or patients requesting the stored electronic patient medical record data; and
means for delivering the transformed electronic patient medical record data to the one of the plurality of healthcare providing institutions, individual healthcare providers or patients.

12. The system of claim 11, further comprising means for mapping healthcare images from a plurality of healthcare providing institutions into the centralized data repository as part of the electronic patient medical record data.

13. The system of claim 11, further comprising means for controlling identities of the healthcare providing institutions, individual healthcare providers and patients, said means for controlling including means for creating a system identity number that is unique for each of the healthcare providing institutions and individual healthcare providers that are accessing the network and for each patient having electronic medical record data in the centralized data repository, and means for associating a respective system identity number with each record of the electronic medical record data.

14. The system of claim 13, further comprising means for tagging patient healthcare activity, said means for tagging including means for creating a health encounter number for each patient visit to a healthcare providing institution or individual healthcare provider, and associating means for storing the health encounter number with the electronic patient medical record data associated with the patient visit into the centralized data repository.

15. The system of claim 14, wherein said means for storing the converted electronic patient medical record data into the centralized data repository includes means for mapping each record of the electronic medical record data in accordance with the system identity number and health encounter number.

16. The system of claim 11, further comprising means for identifying and assimilating terminology from a specific electronic patient medical record data, said means for identifying and assimilating including means for providing a lookup table having a record type identification corresponding to each type of electronic medical record system that submitted any of the electronic patient medical record data.

17. The system of claim 16, said lookup table further including meta class flags corresponding to respective medical term identifications and descriptions for medical terms used by the network and other electronic medical record systems in integrating healthcare information from the plurality of healthcare providing institutions and individual healthcare providers.

18. The system of claim 16, wherein said means for assimilating terminology from the electronic patient medical record data local to the entity into the network further includes means for updating the meta class flag of any of the respective medical term identification and description by matching associated medical term identifications and descriptions.

19. The system of claim 11, further comprising means for accessing the electronic patient medical record data, means for storing core patient data needed for patient care from the electronic patient medical record data into a global chart of the centralized data repository, means for filtering extraneous information that is valuable only to the healthcare providing institution that created the accessed electronic patient medical record data, and means for storing the filtered extraneous information in the centralized data repository separate from the global chart.

20. The system of claim 19, further comprising means for automatically populating one of the plurality of electronic medical record systems with the core patient data of a patient referenced by any of the plurality of healthcare providing institutions or individual healthcare providers.
